(19) United States
(12) Patent Application Publication
(10) Pub. No.: US 2010/0299073 A1
(43) Pub. Date: Nov. 25, 2010

(54) DIVE COMPUTER FOR A PLURALITY OF USERS

(76) Inventors: Lukas Metzler, Appenzell (CH); Markus Mock, Uster (CH); Ernst Voellm, Kilchberg (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/681,024

(22) PCT Filed: Sep. 30, 2008
(86) PCT No.: PCT/EP08/08294

§ 371 Date: Aug. 5, 2010

(30) Foreign Application Priority Data
Oct. 2, 2007 (DE) 10 2007 047 130.2

(51) Int. Cl. G06F 19/00; G01F 23/14

(52) U.S. Cl. 702/19; 73/865.1

(57) ABSTRACT

Dive computer with at least one measuring device for detecting measured variables, at least one memory device, at least one computing device, at least one data transmitter, and one display device for displaying information. The memory device has at least one first area and at least one second area in which data are stored that are allocated to at least one first or at least one second user. There is also a selector for selecting the user to whom the data currently detected by the measuring device are allocated.

The present invention relates to a dive computer that is designed to be carried by divers when diving that comprises at least one measuring device, at least one memory device, at least one computing device, at least one data transmitter, and a display device.

Diving stations in resorts or diving schools frequently have a large number of dive computers on hand. These are made available for participants in organized group dives or individual diving groups. Dive computers help the divers to carry out dives and in particular to avoid decompression problems. The dive depth and dive time are continuously detected during the dive and at least one value is calculated for the nitrogen saturation of the body. An ascent time determined from this with the number of necessary decompression stops and their particular dive depths are displayed for the diver and usually also the determined ambient values or the amount of air remaining in his compressed air tank.

Dive computers available on the market are configured so that the calculation of the nitrogen desaturation of the tissue of the diver is continued up to complete desaturation, for example to be able to include a prevailing residual saturation of tissues of the diver in the further nitrogen saturation calculation in a later dive. Decompression problems can occur even at lower ambient pressure outside of the water after a dive, for example when using an airplane. More reasonably, therefore, divers retain the dive computer until the completion of the desaturation calculation. For consecutive use of a dive computer by multiple divers, numerous dive computer models offer the ability to break off a running desaturation calculation and start a new one. If a previous diver whose calculation has been interrupted starts another dive before his body is fully desaturated, the saturation values calculated by a dive computer differ from the actual values, which can lead to a critical situation for this diver.

The management of multiple dive computers is also associated with great expense. For each user of a dive computer, an individual user profile has to be formulated. This is very tedious on the dive computer itself because of the limited actuation capabilities. However, when using an external computer the profile likewise has to be adapted for each diver individually and carried over to the dive computer.

Furthermore, dives of a plurality of persons, particularly diving students, make increased demands on the divers and particularly on a diving group leader, because of the limited communication possibilities under water. An ability to view information located on the dive computer of a diving partner or student could improve communication between the divers and increase diving safety.

To obtain at least information on the amount of air remaining in the compressed air tank of a diving partner, known dive computers have the ability to display the tank pressure of three compressed air tanks. The dive computer is ordinarily set so that two displays indicate the pressure of the usual two compressed air tanks of his own. The third display can then be used to display the amount of air remaining in a compressed air tank of the diving partner. To do this, however, it is necessary before diving to adjust the dive computer to the identification signal of the pressure sensor on the compressed air tank of the diving partner (so-called pairing).

EP 1 005 723 discloses a system for underwater transmission and a communication network with a communication device for transmitting preset messages between multiple users, at least some of whom are underwater. The underwater transmission described is intended for use with long ranges of more than 150 m and also for persons with no visual contact. However, the communication network allows only the transmission and reception of message ID codes for preset messages stored in both instruments with uniform coding.

The present invention addresses the task of making available a dive computer that can be used for a plurality of users and improves safety in diving.

This task is accomplished by the subject matter of Claim 1. Beneficial refinements are the subject matter of subclaims.

The accomplishment of the task foresees a dive computer that is designed to be carried by divers while diving, with at least one measuring device for detecting measured variables related to the dive, at least one memory device for storing data and program steps, at least one computing device for processing data, at least one data transmitter for exchanging data, and one display device to display information. The memory device has at least one first area and at least one second area in which data are stored that are allocated to at least one first user and at least one second user. There is also a selector that is used to select the user to whom the data currently being detected by the measuring device are allocated.

The suitability of the dive computer for use by a plurality of users is achieved by the fact that it is able to calculate the physical effects of pressure changes on the body, especially the nitrogen saturation and desaturation in the tissues of a plurality of users in parallel, and to display on a display device to a current user the information relevant to him.

According to the invention, individual user accounts are set up on the dive computer in which information related to the diving experience of the diver is preferably stored. A dive safety step is preferably also selected in such a user account for the computer model, which affects the scope of the information displayed for the diver during the dive, for example.

Such a user account also preferably comprises data on the user, for example age, gender, weight, a grading of overall physical condition, and at least the name of the user to allocate the user account. It is also preferable for information such as emergency addresses to be entered in the user account, or information relative to prior illnesses of the user, which should be available in case of an emergency.

If a plurality of user accounts are stored in the memory of a dive computer, then a current user has to be selected before the dive using a selector on the dive computer. This can be done either directly on the dive computer or through a computing device by means of which the dive computer can be accessed. In a preferred embodiment, the selection of the current user is performed on such a computing device, with this selection applying only when it is verified on the dive computer itself. This can prevent an unintentional selection of the wrong user account.

The ambient data detected by the measuring devices of the dive computer are then allocated to the selected user, and the values subsequently determined are displayed for him on the display device. If the desaturation calculation of the previous user has not been completed when changing the user account, then this computing process is preferably continued in the background, preferably with the ambient data prevailing at the time of the changeover. For each user, the computing device preferably stores the data determined for him in an area in the memory device allocated to the user.

The display device preferably displays only the data for the currently selected user account.

If a diver plans to be in an area with lower pressure than at the surface of the water after a dive, for example a mountain trip, then it is appropriate for him to continue to take the dive computer with him. This warns the diver of any pressure conditions possibly dangerous for him in his environment, and thus helps to further avoid decompression problems arising from the diving. If such an undertaking is planned, the diver then continues to wear the dive computer. The dive computer on which the desaturation calculation is continued in this case cannot be available to any other users. Of course, a diver after diving will usually stay in areas with similar pressure conditions as on the shore of the diving locale. In this most likely case, the dive computer can be used by a different user, while the dive computer continues the desaturation calculation for the first user. If the first user decides to take another dive at a later time at which the tissues of his body are not yet completely desaturated and the desaturation calculation is accordingly not yet completed, then by selecting his user account he can base the saturation calculation of the following dive on the currently calculated nitrogen saturation of his body.

Log book entries, which are preferably automatically prepared and stored in the memory area of the user, for example the occurrence of a high oxygen toxicity, are preferably included in a further saturation calculation. The dive computer preferably comprises a modification lock for safety-relevant data so that such information cannot be erased, or a desaturation calculation cannot be broken off, so that these data are also available at a later time.

In an especially preferred embodiment of the dive computer, it is provided that data can be transmitted through data transmitters between a system computing device, which can be a PC, a Macintosh, a Smartphone, or another suitable computing device, for example, and the dive computer. Examples of data transmitters here, for example, are suitable wired systems such as serial or USB interfaces, or wireless data transmitters such as W-LAN, IrDA, or Bluetooth, for example. This makes it possible according to the invention to store and administer a plurality of user accounts as well as a plurality of dive computer accounts on a system computing device. The user data are preferably input there, and settings are established for the dive computer, and these are transmitted through the data transmitter to the dive computer. A plurality of dive computer accounts and a plurality of user accounts are preferably managed in this way, with the data on the system computing device preferably not being able to be changed on it by access to a dive computer. The system computing device can also comprise a plurality of computing devices such as PCs or the like.

The data on the dive computer, especially those generated during the dive, are preferably transmitted to the system computing device after the dive. Thus, for example, a desaturation calculation that would otherwise be continued on a dive computer can also be transmitted to a system computing device and can be continued there. If a user in this case whose desaturation calculation has not yet been completed wants to take another dive, it is possible also to transmit his user data including the desaturation calculation to another dive computer and to continue it there, or to include it in a new saturation calculation.

In another preferred embodiment it is possible to transmit a backup of a dive computer preferably to the system computing device. This backup, for example, can be used for data security or can be rerecorded on another dive computer. This function serves to secure the data, for example, in case of damage or functional problems with a dive computer. There can be another use when a diver whose desaturation calculation has not yet been completed wants to take another dive, while a second user of the dive computer plans to walk a mountain trail, and therefore continues to carry the dive computer with him.

In a preferred embodiment of the dive computer, for safety reasons, the exchange of data between the dive computer and the system computing device takes place only with a computing device assigned to the dive computer. It is preferred for the essential data on the dive computer that cannot be overwritten by other computing devices to be on this computing device. The securing of data by means of a backup or the addition of further data to existing information can be performed for a dive computer on a plurality of computing devices also.

The ability to transfer data between dive computers and the system computing device serves preferably to construct a redundant multi-user system. The transfer of data generated during the dive to the system computing device allows a more thorough interpretation of the dive, for example with regard to the detected ambient parameters (water depth, temperature, dive time, etc.), of the warnings generated, and of other log book entries set up automatically. It is preferably possible to expand log book entries or to add new ones. The ability to transfer data to a computing device also allows discussion of the dive with reference to the data in the group or with a dive group leader.

The dive computer pursuant to the invention preferably also includes data transmitters that are used to transfer data between the dive computers under water. In accordance with the purpose of the multi-user system pursuant to the invention for sports divers with small distances between the diving partners or for professional divers for whom greater ranges are needed, the data are preferably transmitted by means of ultrasound waves that have a frequency in the range of 20 to 600 kHz. An ultrasound frequency range of 20 to 200 kHz has been found to be especially suitable, and for sports divers a frequency range of 20 to 100 kHz is especially preferred. The underwater transmitter in this case is preferably designed so that the transmitting power allows transfer of messages between the dive computers within a range of 25 m or more.

In a preferred embodiment, data transmission by means of electromagnetic long waves is provided for the multi-user system pursuant to the invention, which uses a frequency in the range of 1 to 200 kHz. Such data transmission between the dive computers improves the capabilities of communication between the members of a diving group. The underwater transmitter in this case is preferably designed so that the transmitting power allows transfer of messages between the dive computers within a range of 5 m. In another preferred embodiment, steps can be taken that further increase the range of communication between the dive computers.

According to the invention, the data transmitter on the dive computer, which comprises both transmitter and receiver, preferably also serves to construct a network between the individual dive computers. Because of the constantly changing positions of the various dive computers underwater, a so-called mobile network is preferably formed for this purpose, for example an ad hoc network or a mesh network. Such networks configure and construct themselves automatically. They link the mobile dive computers preferably without a fixed infrastructure, for example an access point that would be used as an interface between the mobile network and a computing device, for example on an escort ship or on the beach. In a network pursuant to the invention, the data are transmitted directly from dive computer to dive computer until the addressee of the message is reached. Suitable routing processes provide that the network continually adapts itself when the dive computers change their positions relative to one another or the number of dive computers available in the network varies.

It is a prerequisite for the construction of such a network that a specific ID is allocated to each dive computer through which a given dive computer can be addressed. This ID is preferably coupled to the user of a dive computer so that the dive computer of a given user can be contacted directly.

In a first embodiment, the dive computers in the network can preferably send predetermined messages to other dive computers. A message in this case can be sent to one or more destination dive computers, or to all of the dive computers that can be reached in the network. The contents of these predetermined messages can preferably be preset freely in the dive computer itself of by means of the system computing device.

In a preferred embodiment, the dive computers communicate bidirectionally with one another. This means that a diver from his own computer can interrogate given messages that are located on the dive computer of a diving partner or of a diving student. In this case, a dive computer sends a query to a given other dive computer, which this other dive computer preferably replies to automatically by sending the desired data to the dive computer from which the query came. It is preferably also possible for a dive computer to send a query to all of the dive computers that can be reached within its range. In this case all of the dive computers that have received the query likewise respond automatically by sending the requested data to the inquiring dive computer. The type of information that can be sent to other dive computers here is preferably limited to safety-relevant data. In another refinement, it is also possible to send certain information only to predetermined dive computers.

This interrogation can be directed, for example, at ambient data such as the dive depth, to dive warnings, or to the remaining basic time of the dive partners. It is also possible in this way for a diver to query the amount of air remaining in the compressed air tank of the diving partner, which is available in his dive computer. Pairing of the interrogating dive computer with the tank pressure sensor of the diving partner is not necessary in this case.

In a preferred embodiment, the dive computer pursuant to the invention includes the ability to release and to limit transmitting or interrogating functions. Individual data relevant to a diving partner can be released here for interrogation, and other data cannot be polled by others. This capability can optionally also be limited to given dive computer identities. For example, interrogation of data of other dive computers can be blocked for the participants in a diving lesson, while on the other hand a diving instructor has access to all of the data of the dive computers of the diving lesson participants.

Other advantages, features, and possible applications of the present invention are found in the following description, combined with the Figures. The Figures show:

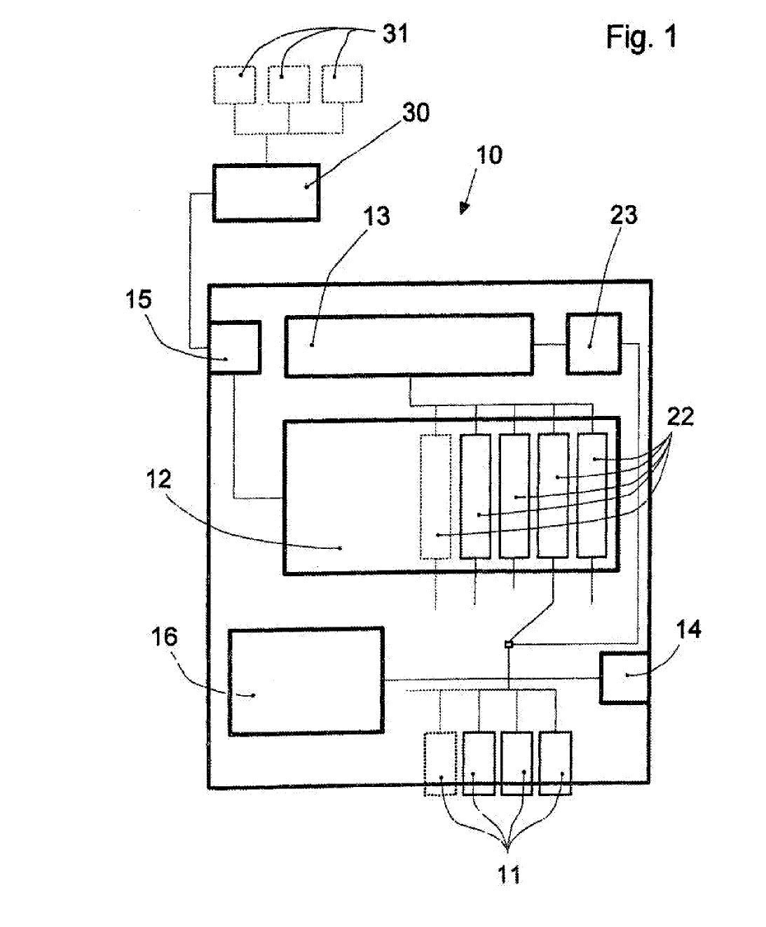

FIG. 1 the structural diagram of an example of a dive computer pursuant to the invention,

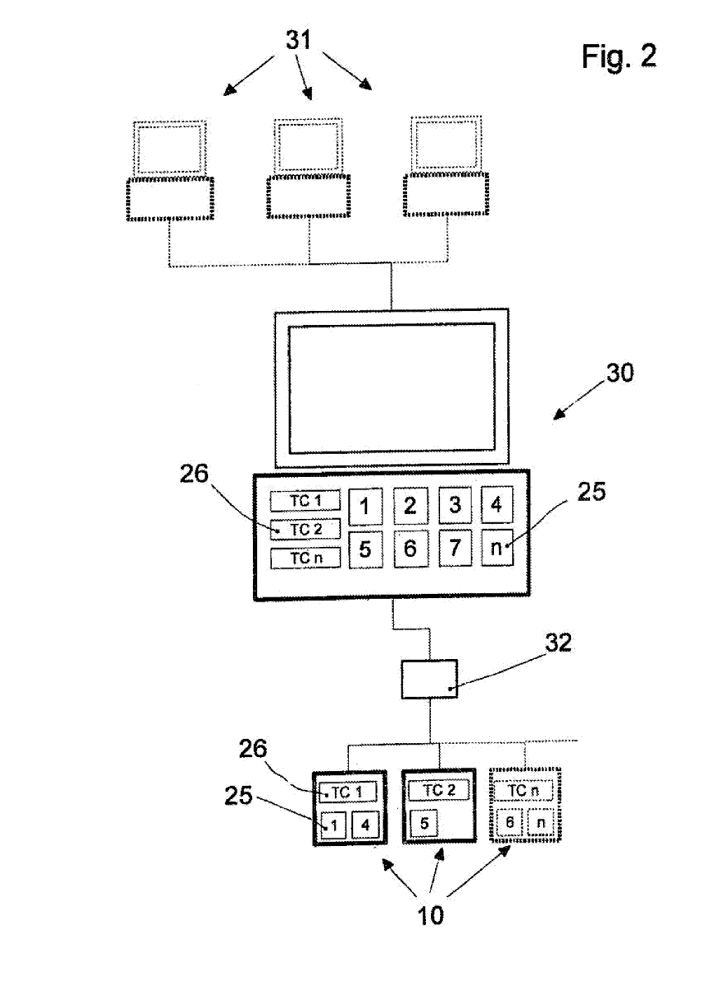

FIG. 2 a schematic illustration of data transfer in a multi-user system, and

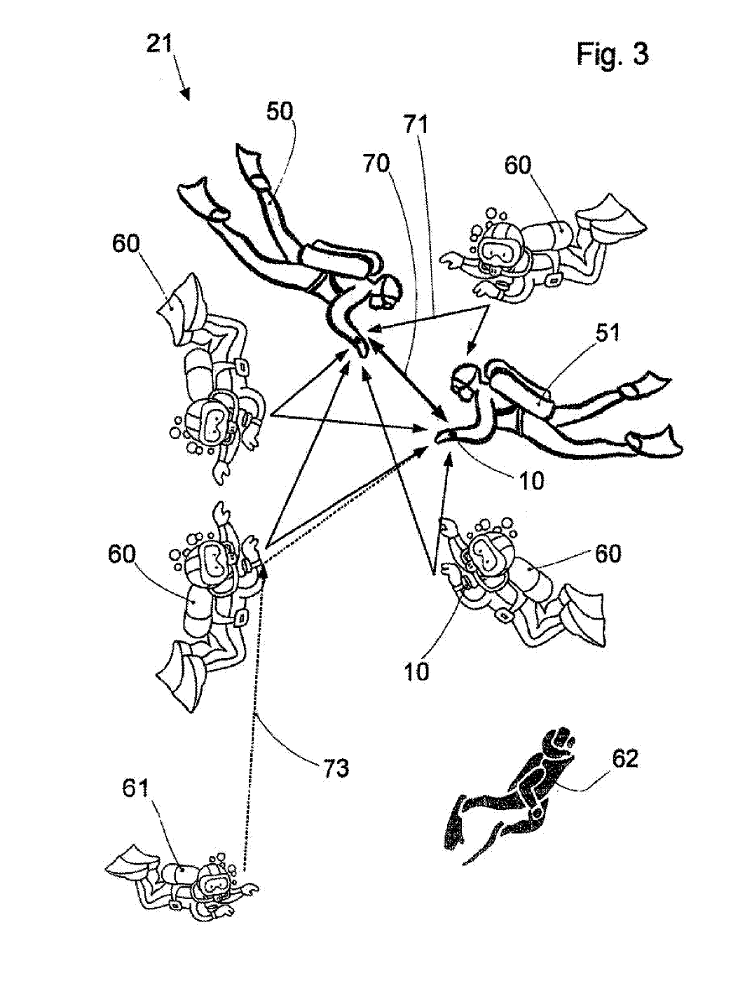

FIG. 3 an example of embodiment of an underwater network pursuant to the invention.

FIG. 1 shows an example of a dive computer 10 pursuant to the invention in schematic illustration. The dive computer comprises a plurality of measuring devices 11, for example to detect the ambient pressure, to calculate the water depth, to detect the pressure in the compressed air tank of the diver, a clock, and possibly other measuring devices necessary for the functional scope of the dive computer. The dive computer 10 also includes a memory device 12 to store the data necessary for the functionality of the dive computer 10, and program steps, a computing device 13 to process the data by means of the program steps stored in the memory device, data transmitters 14 and 15 to exchange data, and a display device 16 on which data detected, generated, and stored by the dive computer relevant to the diver are displayed for him. The memory device 12 has different areas 22 in each of which a user's data are stored. Free access to the needed data is possible in each case in the areas 22 and the other areas in the memory device 12.

The computing device 13 serves to perform all of the computing processes necessary for the functionality of the dive computer. The computing device also comprises a selector 23 that serves to select the area 22 in the memory device 12 in which the data are stored on which the current calculation process is based. The selection process is shown schematically in FIG. 1 through a selection switch that connects only one area 22 to a connecting line to the data transmitter 14, the display device 16, and the measuring devices 11. If a desaturation calculation of a previous user is being executed whose data are stored in an area 22 that is not selected, then the values detected by the measuring devices 11 are no longer the basis for this desaturation calculation.

In addition only the data are displayed in the display device 16 that are allocated to the user in connection with the selected area 22. Also, only data related to the selected user are transferred to the data transmitter 14 that serves for underwater communication. The areas 22 not currently selected are addressable by the display device 16 and the data transmitter 14 only by selecting them.

The dive computer 10 also comprises a data transmitter 15 that serves to exchange the data stored in the memory device 12 with a system computing device 30. Regardless of the selected area 22 of a user, all data from the memory device 12 are available to the data transmitter 15.

FIG. 2 shows a schematic illustration of the data transfer in a multi-user system pursuant to the invention. A plurality n of different user accounts 25 and dive computer accounts 26 that are managed there are stored in a system computing device 30, which may comprise multiple computing devices 31. The data transfer between the system computing device and the various dive computers 10 of the multi-user system takes place through an interface 32. The data from the user accounts 25 or the data from the dive computers 26 in particular are transferred through the interface 32, which in the example of embodiment consists of a USB interface, to the dive computers 10 and are stored there in the memory device 12.

FIG. 3 shows a group of divers 21 and a schematic illustration of the data transfer in a network pursuant to the invention under water. The diving group consists of two diving instructors 50 and 51 and four diving students 60 who stay near the diving instructors 50, 51, and one diving student 61 who is some distance away from the diving instructors 50, 51. Both the diving instructors and the diving students are wearing dive computers 10 pursuant to the invention whose data transfer functions are configured according to the users. The dive computers 10 of the diving instructors 50, 51 are set so that bidirectional communication is possible, and thus all interrogation possibilities are released. Consequently, unlimited communication is possible between the dive computers 10 of the diving instructors 50 and 51, which is shown by the arrow 70.

The bidirectional communication capability for the dive computers 10 of the diving students 60, 61 is limited in such a way that no data can be called in here from other dive computers. This includes data from the dive computers 10 of the diving instructors 50, 51, and data from the dive computers 10 of the other diving students 60, 61. The dive computers of the diving students 60, 61, however, are configured so that messages can be sent from these dive computers 10 to the dive computers 10 of other diving students and of the diving instructors 50, 51. (Not shown by arrows). The diving instructors 50, 51 can call in data from the dive computers 10 of the diving students 60, 61 from their dive computers 10 without limitation; this is shown schematically by the arrows 71.

FIG. 3 illustrates the case in which a diving instructor 51 wants to send a message to a diving student 61, or to query certain data from his dive computer. Of course the diving student 61 is in an area in which the dive computer 10 of the diving instructor 51 cannot reach him because the range of the transmitter is too small. In this case, a routing procedure that is executed in the computing device 13 during the dive determines a path through one or more other dive computers that bridges the distance to the diving student 61. In FIG. 3, this path runs through the dive computer 10 of a diving student 60 that is within the range of the diving student 61. This connection is illustrated by the arrow 73. The desired information is then also returned to the diving instructor 51 through this intermediate dive computer. If the diving student 61 in the meantime has approached the diving instructor 51 enough so that a direct radio link is possible, or a more favorable connection is possible through the dive computer of another diving student 60, then this is determined in the computing device 13 and is used.

If another diver 62 who has a structurally similar dive computer 10 approaches the group of divers 21, he is not in the network of the group of divers 21 and consequently cannot access the data on the dive computers of the diving instructors 50, 51 and diving students 60, 61, and also cannot receive any messages from the dive computers. If he is an additional diving student to be added later, the example of embodiment of the dive computer 10 provides that this diver 61 can send an identification code from his dive computer that identifies him as another participant in the diving group, whereby his dive computer 10 is accepted into the network. The dive computer 10 of the diver 62 can also be configured so that it automatically sends its identification code at given time intervals and is then automatically identified as a participant in the group of divers. Upon approaching the group of divers, the dive computer 10 of the diver 62 is thus automatically accepted into the network of the diving group.

1. Dive computer that is designed to be carried by divers while diving, comprising:
at least one measuring device that detects at least one measured variable related to the dive;
at least one memory device to store data and program steps;
at least one computing device to process data;
at least one wired and/or wireless data transmitter to exchange data and
at least one display device to display information, characterized in that
the memory device has at least one first area in which data related to a first user are stored, and
at least one second area in which data related to a second user are stored, and
a selector is provided that serves to select the user to whom the data detected by the at least one measuring device are allocated.

2. Dive computer pursuant to claim 1, characterized in that the display device displays information relative to the selected user.

3. Dive computer pursuant to claim 1, characterized in that a user account is stored in the memory device for each user for whose body physical effects of pressure changes are calculated.

4. Dive computer pursuant to claim 3, characterized in that the user account includes at least information on the person of the user and/or on his diving experience.

5. Dive computer pursuant to claim 1, characterized in that when a different diver is selected, a desaturation calculation in progress is continued with the current ambient data at the time of the selection.

6. Dive computer pursuant to claim 5, characterized in that by selecting a user whose calculation process has been continued in the background and has not yet been completed, the current values of this desaturation calculation are used as the basis for a further saturation calculation.

7. Dive computer pursuant to claim 1, characterized in that log book entries are made automatically and are stored in the area of the memory device allocated to a user.

8. Dive computer pursuant to claim 1, characterized in that a plurality of dive computer accounts are managed on a system computing device.

9. Dive computer pursuant to claim 1, characterized in that a modification lock prevents changing or erasing safety-related data and/or the interruption of desaturation calculations.

10. Dive computer pursuant to claim 1, characterized in that the at least one data transmitter for exchanging data is wired or wireless.

11. Dive computer pursuant to claim 1, characterized in that user accounts and/or dive computer accounts are transmitted from a system computing device to the dive computer.

12. Dive computer pursuant to claim 1, characterized in that at least some of the data stored in the dive computer are transmitted to a system computing device.

13. Dive computer pursuant to claim 1, characterized in that a backup of a dive computer is prepared and can be transmitted to a system computing device and/or to another dive computer.

14. Dive computer pursuant to claim 1, characterized in that at least one dive computer forms a redundant multi-user system with a system computing device.

15. Dive computer pursuant to claim 1, characterized in that the dive computer comprises a data transmitter that transmits data under water.

16. Dive computer pursuant to claim 15, characterized in that the data are transmitted by means of ultrasound waves whose frequency is in a range of 20 to 600 kHz.

17. Dive computer pursuant to claim 15, characterized in that the data are transmitted by means of electromagnetic long waves whose frequency is in a range of 1 to 200 kHz.

18. Dive computer pursuant to claim 1, characterized in that a mobile network is formed during the dive between at least two dive computers.

19. Dive computer pursuant to claim 18, characterized in that this network is automatically configured and constructed.

20. Dive computer pursuant to claim 18, characterized in that the network includes no fixed infrastructure.

21. Dive computer pursuant to one claim 18, characterized in that a specific ID is allocated to each dive computer.

22. Dive computer pursuant to claim 18, characterized in that the dive computers in the network communicate bidirectionally with one another.

23. Dive computer pursuant to claim 22, characterized in that transmitting and interrogating functions of the dive computer are configurable.

24. Dive computer pursuant to claim 15, characterized in that the data are transmitted by means of ultrasound waves whose frequency is in a range of 20 to 200 kHz.

25. Dive computer pursuant to claim 15, characterized in that the data are transmitted by means of ultrasound waves whose frequency is in a range of 20 to 60 kHz.

26. Dive computer pursuant to claim 2, characterized in that:
a user account is stored in the memory device for each user for whose body physical effects of pressure changes are calculated;
the user account includes at least information on the person of the user and/or on his diving experience;
when a different diver is selected, a desaturation calculation in progress is continued with the current ambient data at the time of the selection;
by selecting a user whose calculation process has been continued in the background and has not yet been completed, the current values of this desaturation calculation are used as the basis for a further saturation calculation;
log book entries are made automatically and are stored in the area of the memory device allocated to a user;
a plurality of dive computer accounts are managed on a system computing device;
a modification lock prevents changing or erasing safety-related data and/or the interruption of desaturation calculations;
the at least one data transmitter for exchanging data is wired or wireless;
user accounts and/or dive computer accounts are transmitted from a system computing device to the dive computer;
at least some of the data stored in the dive computer are transmitted to a system computing device;
a backup of a dive computer is prepared and can be transmitted to a system computing device and/or to another dive computer;
at least one dive computer forms a redundant multi-user system with a system computing device;
the dive computer comprises a data transmitter that transmits data under water;
a mobile network is formed during the dive between at least two dive computers;
this network is automatically configured and constructed;
the network includes no fixed infrastructure;
a specific ID is allocated to each dive computer;
the dive computers in the network communicate bidirectionally with one another; and
transmitting and interrogating functions of the dive computer are configurable.

27. Dive computer pursuant to claim 26, characterized in that the data are transmitted by means of electromagnetic long waves whose frequency is in a range of 1 to 200 kHz.

28. Dive computer pursuant to claim 26, characterized in that the data are transmitted by means of ultrasound waves whose frequency is in a range of 20 to 600 kHz.

29. Dive computer pursuant to claim 26, characterized in that the data are transmitted by means of ultrasound waves whose frequency is in a range of 20 to 200 kHz.

30. Dive computer pursuant to claim 26, characterized in that the data are transmitted by means of ultrasound waves whose frequency is in a range of 20 to 60 kHz.
